(19) United States
(12) Patent Application Publication
(10) Pub. No.: US 2026/0351852 A1
(43) Pub. Date: Nov. 5, 2026

(54) ANTENNA ASSEMBLY AND ELECTRONIC DEVICE

(71) Applicant: GUANGDONG COROS SPORTS TECHNOLOGY CO., LTD, Dongguan (CN)

(72) Inventor: ZHANG WANG, Dongguan (CN)

(21) Appl. No.: 19/688,608

(22) Filed: May 27, 2026

Related U.S. Application Data
(63) Continuation of application No. PCT/CN2024/114586, filed on Aug. 26, 2024.

(51) Int. Cl. H01Q 7/00; H01Q 1/24; H01Q 5/20; H01Q 5/328; H01Q 5/50

(52) U.S. Cl. CPC H01Q 7/00; H01Q 1/241; H01Q 5/20; H01Q 5/328; H01Q 5/50

(57) ABSTRACT

An antenna assembly and an electronic device are provided. The antenna assembly includes a ring radiator and a first matching circuit. The ring radiator includes at least a first feed node, a first ground node, a second ground node, a first radiating portion and a second radiating portion. The first radiating portion and the second radiating portion are configured to transmit signals in a first operating frequency band and a second operating frequency band, respectively. The first radiating portion includes an arc segment located between the first feed node and the first ground node. The second radiating portion includes an arc segment located between the first ground node and the second ground node. The first feed node is grounded via the first matching circuit, and the first matching circuit is a capacitive circuit or an inductive circuit.

### TECHNICAL FIELD

The present disclosure relates to the field of antenna technologies, and in particular, to an antenna assembly and an electronic device.

### BACKGROUND

With the development of electronic devices such as wearable devices and mobile phones, satellite positioning has become one of their main functions. A satellite positioning antenna is essential for achieving satellite positioning and trajectory recording.

The miniaturization of electronic devices also poses challenges to the design of satellite positioning antennas. In related technologies, a satellite positioning antenna usually occupies a large area, which is not conducive to the integration of other antennas in electronic devices. Alternatively, other antennas and the satellite positioning antenna may be arranged in an overlapping manner in an electronic device, but this may cause mutual interference between different antennas and increase the complexity of antenna design and debugging.

### SUMMARY OF THE INVENTION

The present disclosure provides an antenna assembly and an electronic device, aiming to improve the integration of antennas on a ring radiator and reduce signal interference between different antennas when multiple antennas are integrated.

In a first aspect, one embodiment of the present disclosure provides an antenna assembly, including:
a ring radiator, the ring radiator including at least a first feed node, a first ground node, and a second ground node;
the ring radiator including a first radiating portion and a second radiating portion, the first radiating portion being configured to transmit signals in a first operating frequency band, and the second radiating portion being configured to transmit signals in a second operating frequency band;
the first radiating portion including an arc segment located between the first feed node and the first ground node;
the second radiating portion including an arc segment located between the first ground node and the second ground node; and
a first matching circuit, wherein the first feed node is grounded via the first matching circuit, and the first matching circuit is a capacitive circuit or an inductive circuit.

In a second aspect, one embodiment of the present disclosure provides an electronic device, in which the electronic device includes the foregoing antenna assembly.

In the antenna assembly and the electronic device provided in the embodiments of the present disclosure, the antenna assembly includes a ring radiator and a first matching circuit. The ring radiator includes at least a first feed node, a first ground node, and a second ground node, and the ring radiator includes a first radiating portion and a second radiating portion, where the first radiating portion is configured to transmit signals in a first operating frequency band, and the second radiating portion is configured to transmit signals in a second operating frequency band; the first radiating portion includes an arc segment located between the first feed node and the first ground node; the second radiating portion includes an arc segment located between the first ground node and the second ground node; the first feed node is grounded via the first matching circuit, and the first matching circuit is a capacitive circuit or an inductive circuit. By configuring the first radiating portion and the second radiating portion of the ring radiator to share the same ground node, namely the first ground node, the lengths of arc segments occupied on the ring radiator by the first radiating portion for transmitting signals in the first operating frequency band and the second radiating portion for transmitting signals in the second operating frequency band can be reduced, thus reducing signal interference between different antennas when multiple antennas are integrated. By arranging that the first feed node is grounded via the first matching circuit, the impedance of the first radiating portion with respect to signals in the first operating frequency band and the impedance of the second radiating portion with respect to signals in the second operating frequency band can be adjusted, so as to improve the overall radiation efficiency of the antenna assembly with respect to signals in the first operating frequency band and the second operating frequency band.

It should be understood that the foregoing general description and the following detailed description are exemplary and explanatory, and do not limit the disclosure of the embodiments of the present disclosure.

### BRIEF DESCRIPTION OF THE DRAWINGS

To more clearly expound the technical solution of embodiments of the present disclosure, a brief description will be provided below for the drawings that are necessary for illustrating the embodiments. Obviously, the drawings described below are provided for some of the embodiments of the present disclosure, and based on such drawings, those having ordinary skill in the art may envisage other drawings without creative endeavor.

FIG. 1 is a schematic structural diagram showing an antenna assembly according to one embodiment of the present disclosure;

FIGS. 2 to 4 are schematic structural diagrams showing antenna assemblies according to some embodiments of the present disclosure;

FIG. 5 is a schematic diagram showing the radiation efficiency of an antenna assembly according to some embodiments of the present disclosure;

FIG. 6 is a schematic diagram showing the radiation efficiency of an antenna assembly in related art;

FIG. 7a is a schematic structural diagram showing an antenna assembly according to another embodiments of the present disclosure;

FIG. 7b is a schematic diagram showing a first matching circuit according to some embodiments of the present disclosure;

FIG. 8 is a schematic structural diagram showing an antenna assembly according to still other embodiments of the present disclosure;

FIG. 9 is a schematic structural diagram showing an electronic device according to one embodiment of the present disclosure;

FIGS. 10a to 10c are schematic structural diagrams showing an antenna assembly of an electronic device according to some embodiments of the present disclosure.

### LIST OF REFERENCE SIGNS

100, ring radiator; S1, first arc segment; S2, second arc segment;
10, first radiating portion; 20, second radiating portion; 200, feed node; 300, ground node;
201, first feed node; 301, first ground node; 302, second ground node; 202, second feed node; 303, third ground node; 304, fourth ground node;
30, first matching circuit; 301, capacitor; 302, inductor; 40, second matching circuit; 50, third radiating portion;
101, circuit board; 60, housing; 61, bottom wall; 62, side wall; 63, metal base plate.

### DETAILED DESCRIPTION

The technical solutions in the embodiments of the present disclosure will be clearly and completely described below with reference to the drawings. Obviously, the described embodiments are some embodiments of the present disclosure, and not all embodiments. Based on the embodiments in the present disclosure, all other embodiments obtained by those having ordinary skill in the art without creative endeavor shall fall within the protection scope of the present disclosure.

It should be understood that the present disclosure may be implemented in different forms and should not be construed as being limited to the embodiments set forth herein. Instead, these embodiments are provided to make the present disclosure thorough and complete, and to fully convey the scope of the present disclosure to those having ordinary skill in the art. In the drawings, the dimensions and relative dimensions of layers and regions may be exaggerated for clarity, and like reference numerals refer to like elements throughout.

To provide a thorough understanding of the present disclosure, detailed structures and steps will be set forth in the following description to illustrate the technical solutions proposed by the present disclosure. The preferred embodiments of the present disclosure are described in detail below; however, in addition to these detailed descriptions, the present disclosure may have other embodiments.

Some embodiments of the present disclosure will be described in detail below with reference to the drawings. The following embodiments and features in the embodiments may be combined with each other without conflict.

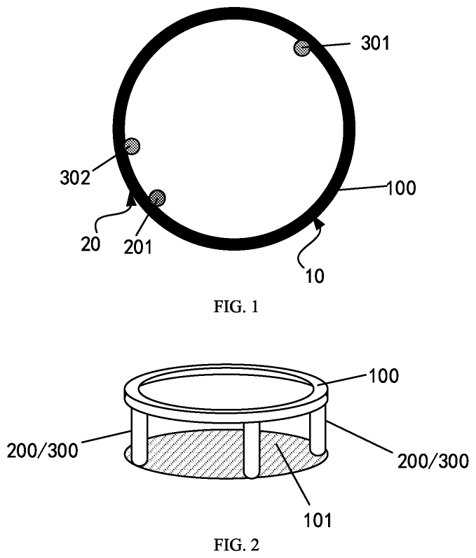

Referring to FIG. 1, FIG. 1 is a schematic structural diagram showing an antenna assembly according to one embodiment of the present disclosure.

As shown in FIG. 1, the antenna assembly includes a ring radiator 100. In some embodiments, the ring radiator 100 may be a circular ring radiator 100. In other embodiments, the ring radiator 100 may be an elliptical ring radiator 100.

The ring radiator 100 includes at least a first feed node 201, a first ground node 301, and a second ground node 302.

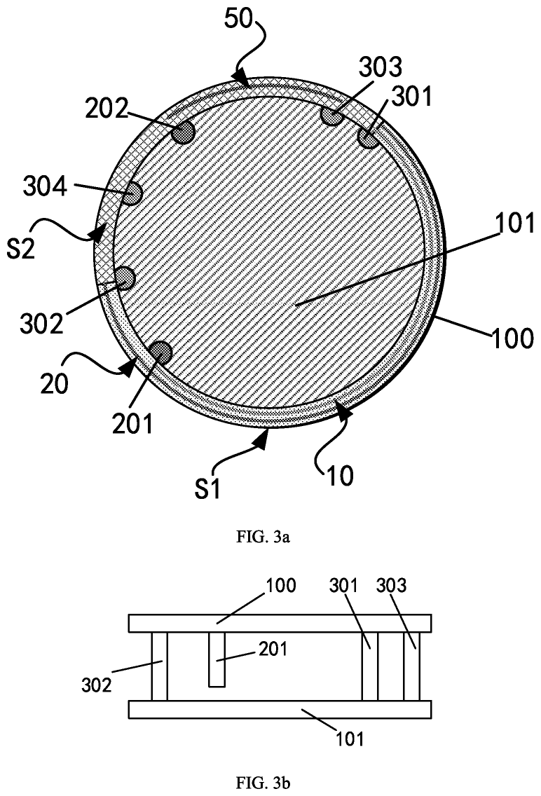

As shown in FIG. 2, the ring radiator 100 includes at least one feed node 200 and at least one ground node 300. In some embodiments, referring to FIGS. 3a and 3b in conjunction with FIG. 2, the antenna assembly may be coupled to a circuit board 101, where the feed node 200 is a node coupled to a feed port on the circuit board 101, and the ground node 300 is a node coupled to a ground port on the circuit board 101. Optionally, the feed node 200 and the ground node 300 may be coupled to the circuit board 101 via conductive posts. The conductive posts may both couple the antenna assembly to the circuit board 101 and provide physical support between the ring radiator 100 and the circuit board 101.

As shown in FIG. 1 or FIG. 3a and FIG. 3b, the ring radiator 100 includes a first radiating portion 10 and a second radiating portion 20. The first radiating portion 10 is configured to transmit signals in a first operating frequency band, and the second radiating portion 20 is configured to transmit signals in a second operating frequency band. For ease of description, the embodiments of the present disclosure are mainly illustrated by taking an example in which the center frequency of the first operating frequency band is greater than the center frequency of the second operating frequency band.

The first radiating portion 10 includes an arc segment located between the first feed node 201 and the first ground node 301. In some embodiments, a circuit on the circuit board 101 may receive signals in the first operating frequency band coupled by the first radiating portion 10 via the first feed node 201, and/or the circuit on the circuit board 101 may apply signals in the first operating frequency band to the first feed node 201, and the first radiating portion 10 can transmit the signals of the first operating frequency band.

The second radiating portion 20 includes an arc segment located between the first ground node 301 and the second ground node 302.

In some embodiments, the circuit on the circuit board 101 may receive signals in the second operating frequency band coupled by the second radiating portion 20 via the first feed node 201, and/or the circuit on the circuit board 101 may apply signals in the second operating frequency band to the first feed node 201, and the second radiating portion 20 can transmit the signals of the second operating frequency band.

The first ground node 301 is disposed on the first radiating portion 10 and also on the second radiating portion 20, that is, the first radiating portion 10 and the second radiating portion 20 share the first ground node 301.

By configuring the first radiating portion 10 and the second radiating portion 20 of the ring radiator 100 to share the same ground node 300, namely the first ground node 301, the lengths of arc segments occupied on the ring radiator 100 by the first radiating portion 10 for transmitting signals in the first operating frequency band and the second radiating portion 20 for transmitting signals in the second operating frequency band can be reduced.

In some embodiments, as shown in FIG. 1, the length of the arc segment between the first feed node 201 and the first ground node 301 is less than the length of the arc segment between the first ground node 301 and the second ground node 302. In some embodiments, the length of the first radiating portion 10 is less than the length of the second radiating portion 20, which can be applied to a situation where the center frequency of the first operating frequency band is greater than the center frequency of the second operating frequency band, ensuring the efficiency of the first radiating portion 10 in transmitting and/or receiving signals in the first operating frequency band, and ensuring the efficiency of the second radiating portion 20 in transmitting and/or receiving signals in the second operating frequency band.

In some embodiments, as shown in FIG. 1 or FIG. 3a and FIG. 3b, the first feed node 201 is disposed between the first ground node 301 and the second ground node 302, so that the length of the arc segment between the first feed node 201 and the first ground node 301 is less than the length of the arc segment between the first ground node 301 and the second ground node 302.

In some embodiments, as shown in FIGS. 3a and 3b, the ring radiator 100 includes a first arc segment S1 and a second arc segment S2 between the first ground node 301 and the second ground node 302, that is, the first ground node 301 and the second ground node 302 divide the ring radiator 100 into the first arc segment S1 and the second arc segment S2. The first feed node 201 is disposed on the first arc segment S1.

For example, the entire first arc segment S1 serves as the second radiating portion 20, and a portion of the first arc segment S1 adjacent to the first ground node 301 serves as the first radiating portion 10. Optionally, the first feed node 201 is disposed on a side of the first arc segment S1 adjacent to the second ground node 302, or in other words, the length of the arc segment between the first feed node 201 and the second ground node 302 is less than the length of the arc segment between the first feed node 201 and the first ground node 301.

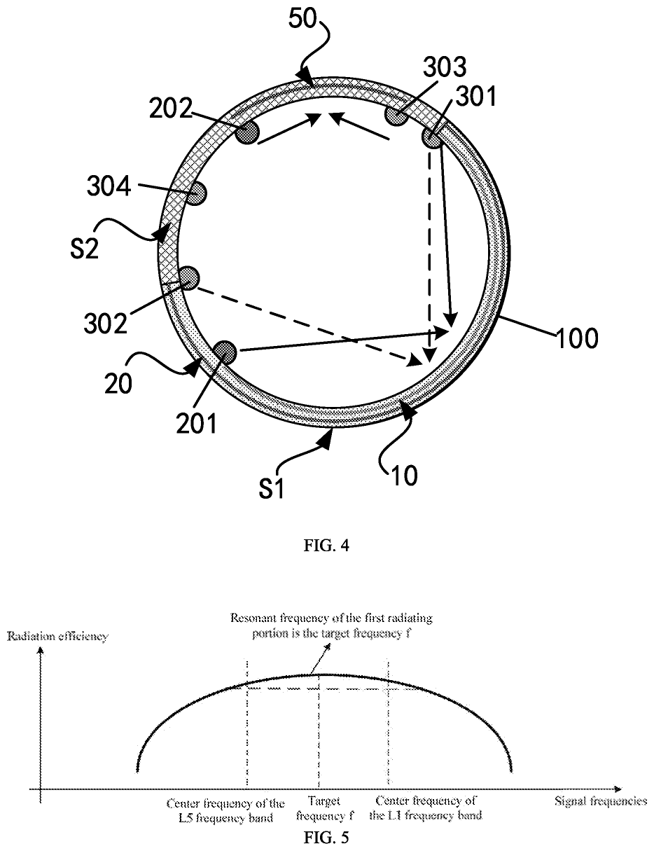

As shown in FIG. 1 or FIG. 3a and FIG. 3b, the first radiating portion 10 and the second radiating portion 20 of the ring radiator 100 partially overlap, that is, the first radiating portion 10 and the second radiating portion 20 are arranged in a co-aperture manner. FIG. 4 shows a current distribution diagram of the antenna assembly in one embodiment, where a solid line with arrows between the first feed node 201 and the first ground node 301 represents the current distribution of L1-band signals on the first radiating portion 10, and a dashed line with arrows between the first ground node 301 and the second ground node 302 represents the current distribution of L5-band signals on the second radiating portion 20.

By arranging the first radiating portion 10 and the second radiating portion 20 in a co-aperture manner on the ring radiator 100, the lengths of arc segments occupied on the ring radiator 100 by the first radiating portion 10 for transmitting signals in the first operating frequency band and the second radiating portion 20 for transmitting signals in the second operating frequency band can be reduced.

In some embodiments, reducing the lengths of arc segments occupied by the first radiating portion 10 and the second radiating portion 20 facilitates the arrangement of radiating portions with respect to signals in other operating frequency bands on other arc segments of the ring radiator 100. Optionally, as shown in FIG. 3a or FIG. 4, the ring antenna assembly further includes a second feed node 202 and a third ground node 303 disposed on the second arc segment S2. The ring radiator 100 further includes a third radiating portion 50. The third radiating portion 50 includes a portion of the second arc segment S2 located between the second feed node 202 and the third ground node 303. The third radiating portion 50 is configured to transmit signals in a third operating frequency band. Of course, the present disclosure is not limited thereto. In some embodiments, the ring radiator 100 may further include a fourth radiating portion configured to transmit signals in a fourth operating frequency band. The integration of the antenna assembly can be improved by providing at least the third radiating portion 50 on the ring radiator 100.

The third radiating portion 50 is disposed on the second arc segment S2 of the ring radiator 100, as shown in FIG. 3a or FIG. 4. The second arc segment S2 is separated from the first arc segment S1 by the first ground node 301 and the second ground node 302, so that the second arc segment S2 is an arc segment of the ring radiator 100 other than the first arc segment S1. Since the lengths of arc segments occupied by the first radiating portion 10 and the second radiating portion 20 are relatively small, sufficient space is reserved for disposing the third radiating portion 50. In some embodiments, a separation distance between the third radiating portion 50 and each of the first radiating portion 10 and the second radiating portion 20 may be larger, and additional grounding may also be provided, so as to reduce electromagnetic interference between the third radiating portion 50 and each of the first radiating portion 10 and the second radiating portion 20, thus improving the reliability of the antenna assembly.

In some embodiments, the first operating frequency band is an L1 frequency band of a Global Navigation Satellite System (GNSS), and the second operating frequency band is an L5 frequency band of the Global Navigation Satellite System. The first radiating portion 10 can be referred to as an L1 antenna, and the second radiating portion 20 can be referred to as an L5 antenna. The L1 frequency band has a frequency of approximately 1.6 GHz, and the L5 frequency band has a frequency of approximately 1.2 GHz. In some embodiments, the antenna assembly receives positioning signals from the Global Navigation Satellite System. The electronic device can determine position information based on the positioning signals received by the antenna assembly, and can further display the position information, for example, by displaying a current position on a map based on the position information. It should be noted that the L1 frequency band and the L5 frequency band in the embodiments of the present disclosure are illustrative examples of the first operating frequency band and the second operating frequency band. It should be understood that at least one of the first operating frequency band and the second operating frequency band may also be another frequency band, for example, an L2 frequency band of the Global Navigation Satellite System.

In some embodiments, the third operating frequency band is a Bluetooth and/or WiFi frequency band, and the third radiating portion 50 may be referred to as a Bluetooth and/or WiFi antenna. In some embodiments, the circuit on the circuit board 101 may receive signals in the third operating frequency band coupled by the third radiating portion 50 via the second feed node 202, and/or the circuit on the circuit board 101 may apply signals in the third operating frequency band to the second feed node 202, and the third radiating portion 50 can transmit the signals in the third operating frequency band. An electronic device equipped with the antenna assembly can communicate with other devices via Bluetooth and/or WiFi.

In some embodiments, Bluetooth technology plays a crucial role in electronic devices such as smartwatches. Through a Bluetooth antenna, a smartwatch can sync data with a smartphone or other Bluetooth-compatible devices, so that a user can view exercise data, receive notifications, and even control music playback in real time. In some embodiments, the length of the first radiating portion 10 is ¼ of the wavelength corresponding to a target frequency. The target frequency is greater than a center frequency of the second operating frequency band and less than a center frequency of the first operating frequency band.

In some embodiments, in a case where the first operating frequency band is the L1 frequency band and the second operating frequency band is the L5 frequency band, the target frequency is greater than the center frequency of the L5 frequency band and less than the center frequency of the L1 frequency band.

In some embodiments, a resonant frequency corresponding to the first radiating portion 10 is greater than 1.1 times the center frequency of the second operating frequency band and less than 0.9 times the center frequency of the first operating frequency band.

In some embodiments, in a case where the first operating frequency band is the L1 frequency band and the second operating frequency band is the L5 frequency band, an equivalent antenna length corresponding to the first radiating portion 10 is greater than or equal to 10 cm and less than or equal to 12 cm.

As shown in FIG. 1 or FIG. 3a, the first radiating portion 10 and the second radiating portion 20 are arranged in a co-aperture manner. The length of the first radiating portion 10 is ¼ of the wavelength corresponding to the target frequency, which allows the first arc segment S1 to resonate at the target frequency f. Referring to FIG. 5, the first radiating portion 10 has high radiation efficiency for signal frequencies in the first operating frequency band (such as the L1 frequency band), and the second radiating portion 20 also has high radiation efficiency (above the horizontal dashed line) for signal frequencies in the second operating frequency band (such as the L5 frequency band). It can be seen from FIG. 5 that when the first arc segment S1 resonates at the target frequency f, the first radiating portion 10 and the second radiating portion 20 each have high antenna radiation efficiency in at least the L1 frequency band and the L5 frequency band of the Global Navigation Satellite System.

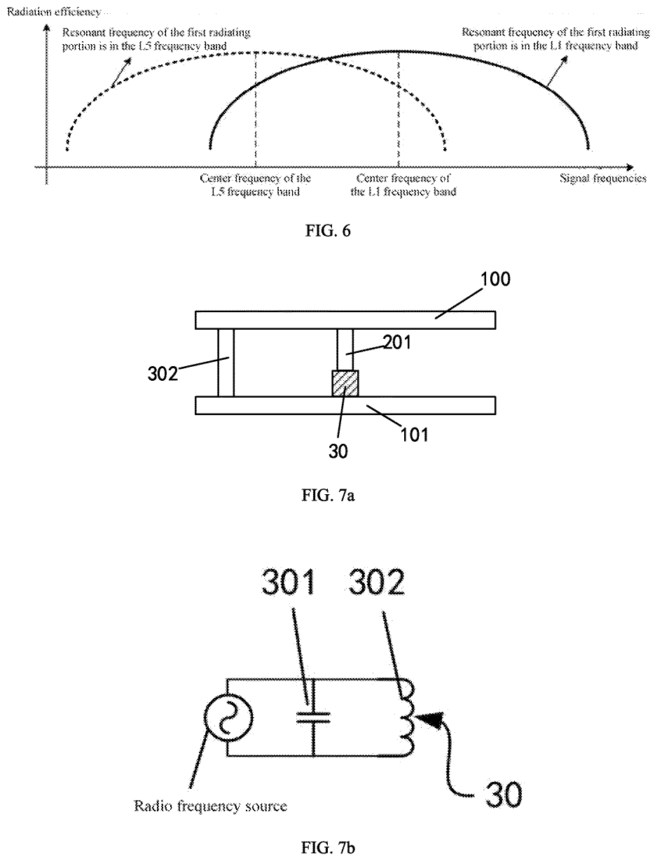

For ease of description, referring to FIG. 6, FIG. 6 is a schematic diagram showing the radiation efficiency corresponding to different signal frequencies when the resonant frequency of the first radiating portion 10 is in the L1 frequency band or the L5 frequency band. When the resonant frequency of the first radiating portion 10 is in the L5 frequency band, the first radiating portion 10 has low radiation efficiency for signal frequencies in the L1 frequency band. When the resonant frequency of the first radiating portion 10 is in the L1 frequency band, the first radiating portion 10 has low radiation efficiency for signal frequencies in the L5 frequency band. For signals from the Global Navigation Satellite System, a significant reduction in the antenna radiation efficiency is unacceptable. In the embodiments of the present disclosure, the length of the first radiating portion 10 is configured to be ¼ of the wavelength corresponding to the target frequency, so that the first radiating portion 10 and the second radiating portion 20, which are arranged in a co-aperture manner of the antenna assembly, each have high antenna radiation efficiency for signals from the Global Navigation Satellite System.

In some embodiments, the target frequency may be an average value of the center frequency of the L5 frequency band and the center frequency of the L1 frequency band.

In some embodiments, a difference between the target frequency and the center frequency of the L5 frequency band is smaller than a difference between the target frequency and the center frequency of the L1 frequency band. By configuring the target frequency closer to the center frequency of the L5 frequency band, the radiation efficiency of the first radiating portion 10 for L5-band signals can be further improved, compared with configuring the target frequency closer to the center frequency of the L1 frequency band.

In some embodiments, referring to FIG. 4, the second ground node 302 is provided outside the first feed node 201 of the first radiating portion 10, which can affect the current distribution of L5-band signals on the second radiating portion 20, for example, can affect efficiency and an axial ratio of the second radiating portion 20 in transmitting L5-band signals.

In some embodiments, by configuring the distance between the first feed node 201 and the second ground node 302, the efficiency and the axial ratio of the second radiating portion 20 in transmitting L5-band signals can be adjusted, or in other words, aperture tuning for the L5 frequency band can be achieved, for example, the axial ratio and efficiency of the Global Navigation Satellite System antenna can be improved.

In some embodiments, as shown in FIG. 7a, the antenna assembly further includes a first matching circuit 30, and the first feed node 201 is grounded via the first matching circuit 30. In some embodiments, as shown in FIG. 7b, the first matching circuit 30 includes a capacitor 301 and an inductor 302, and the capacitor 301 and the inductor 302 are connected in parallel.

The first matching circuit 30 may adjust the impedance of the first radiating portion 10 with respect to signals in the first operating frequency band, and may at least achieve impedance matching of the first radiating portion 10 with respect to signals in the first operating frequency band. In some embodiments, for at least one frequency in the first operating frequency band, the equivalent impedance between the first feed node 201 and the first ground node 301 is 50 ohms, so as to at least reduce the return loss of the first radiating portion 10 with respect to signals in the first operating frequency band.

The first matching circuit 30 may adjust the impedance of the second radiating portion 20 with respect to signals in the second operating frequency band, and may at least achieve impedance matching of the second radiating portion 20 with respect to signals in the second operating frequency band to a certain extent. In some embodiments, for at least one frequency in the second operating frequency band, the equivalent impedance of the second radiating portion 20 is equal to 50 ohms or close to 50 ohms, so as to reduce the return loss of the second radiating portion 20 with respect to signals in the second operating frequency band. Therefore, the overall radiation efficiency of the antenna assembly with respect to signals in the first operating frequency band and the second operating frequency band can be improved.

Optionally, the first matching circuit 30 is a capacitive circuit. In some embodiments, the first matching circuit 30 includes a capacitor 301. Compared with a configuration in which the first matching circuit 30 is not provided or the first matching circuit 30 is configured as an inductive circuit, configuring the first matching circuit 30 as a capacitive circuit allows the first radiating portion 10 to be equivalent to a shorter current path for signals in the first operating frequency band, and allows the second radiating portion 20 to be equivalent to a shorter current path for signals in the L5 frequency band, enabling adjustment of the impedance and resonant frequencies of the first radiating portion 10 and the second radiating portion 20, and thus improving the transmission performance of the first radiating portion 10 for L1-band signals and the transmission performance of the second radiating portion 20 for L5-band signals, for example, by ensuring that the first radiating portion 10 and the second radiating portion 20 have favorable impedance characteristics and radiation efficiency.

Optionally, the first matching circuit 30 is an inductive circuit. In some embodiments, the first matching circuit 30 includes an inductor 302. Compared with a configuration in which the first matching circuit 30 is not provided or the first matching circuit 30 is configured as a capacitive circuit, configuring the first matching circuit 30 as an inductive circuit allows the first radiating portion 10 to be equivalent to a longer current path for signals in the first operating frequency band, and allows the second radiating portion 20 to be equivalent to a longer current path for signals in the L5 frequency band, enabling adjustment of the impedance and resonant frequencies of the first radiating portion 10 and the second radiating portion 20, and thus improving the transmission performance of the first radiating portion 10 for L1-band signals and transmission performance of the second radiating portion 20 for L5-band signals, for example, by ensuring that the first radiating portion 10 and the second radiating portion 20 have favorable impedance characteristics and radiation efficiency.

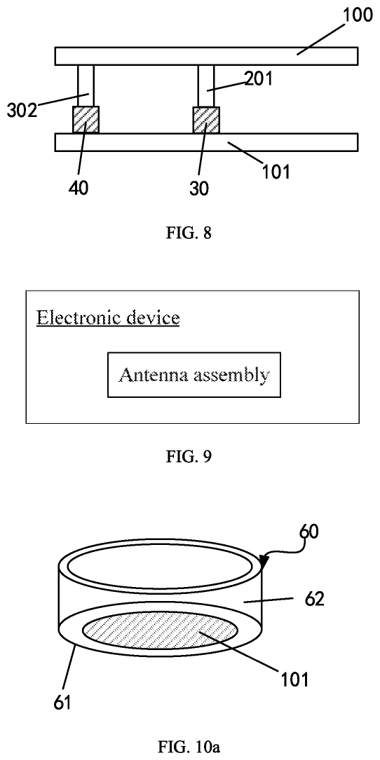

In some embodiments, as shown in FIG. 8, the antenna assembly may further include a second matching circuit 40, and the second ground node 302 is grounded via the second matching circuit 40. The second ground node 302 is configured to be grounded via the second matching circuit 40, which may assist in adjusting the transmission performance of the second radiating portion 20 with respect to signals in the second operating frequency band, so that the second radiating portion 20 has favorable impedance characteristics and radiation efficiency for signals in the second operating frequency band.

In some embodiments, the second matching circuit 40 includes a capacitor and an inductor, and the capacitor and the inductor are connected in parallel. A structure of the second matching circuit 40 may be the same as or similar to the structure of the first matching circuit 30 shown in FIG. 7b, and will not be described in detail here.

Optionally, after adjusting the equivalent impedance between the first feed node 201 and the first ground node 301 to 50 ohms for at least one frequency in the first operating frequency band via the first matching circuit 30, the distance between the first feed node 201 and the second ground node 302 can be adjusted, and/or the parameters of the second matching circuit 40 can be adjusted, so that the equivalent impedance of the second radiating portion 20 is 50 ohms for at least one frequency in the second operating frequency band, thus improving the overall radiation efficiency of the antenna assembly for signals in the first operating frequency band and the second operating frequency band.

Optionally, the second matching circuit 40 is a capacitive circuit. In some embodiments, the second matching circuit 40 includes a capacitor. Compared with a configuration in which the second matching circuit 40 is not provided or the second matching circuit 40 is configured as an inductive circuit, configuring the second matching circuit 40 as a capacitive circuit allows the second radiating portion 20 to be equivalent to a shorter current path for signals in the L5 frequency band, enabling auxiliary adjustment of the impedance and resonant frequency of the second radiating portion 20, that is, improving the transmission performance of the second radiating portion 20 for L5-band signals, for example, by enabling the second radiating portion 20 to have favorable impedance characteristics and radiation efficiency.

Optionally, the second matching circuit 40 is an inductive circuit. In some embodiments, the second matching circuit 40 includes an inductor. Compared with a configuration in which the second matching circuit 40 is not provided or the second matching circuit 40 is configured as a capacitive circuit, configuring the second matching circuit 40 as an inductive circuit allows the second radiating portion 20 to be equivalent to a longer current path for signals in the L5 frequency band, enabling auxiliary adjustment of the impedance and resonant frequency of the second radiating portion 20, that is, improving the transmission performance of the second radiating portion 20 for L5-band signals, for example, by enabling the second radiating portion 20 to have favorable impedance characteristics and radiation efficiency.

It should be noted that the design of a Bluetooth antenna needs to take into account factors such as power consumption, signal range, communication rate, and coordination with other wireless communication modules. Embodiments of the present disclosure further design a third radiating portion to improve performance of the Bluetooth antenna.

In some embodiments, as shown in FIG. 4, the length of an arc segment between the third ground node 303 of the third radiating portion and the first ground node 301 (shared by the first radiating portion and the second radiating portion) is less than the length of an arc segment between the second feed node 202 and the first ground node 301. In some embodiments, the ground node 300 of the third radiating portion is disposed adjacent to the ground node 300 of the first radiating portion and the second radiating portion, and the feed node 200 of the third radiating portion (i.e., the second feed node 202) is disposed adjacent to the feed node 200 of the first radiating portion and the second radiating portion (i.e., the first feed node 201), which facilitates improving the overall radiation efficiency of the antenna assembly for signals in the first operating frequency band, the second operating frequency band, and the third operating frequency band, and can reduce mutual signal interference.

Optionally, referring to FIG. 4, the ring radiator 100 further includes a fourth ground node 304, and the fourth ground node 304 is located between the second feed node 202 and the second ground node 302. As shown in FIG. 4, a solid line with arrows between the second feed node 202 and the third ground node 303 represents the current distribution of Bluetooth signals on the third radiating portion 50. The fourth ground node 304 is disposed between the second feed node 202 of the third radiating portion and the second ground node 302 of the second radiating portion, which helps improve the isolation between the third radiating portion and each of the first radiating portion and the second radiating portion. For example, signal interference between Global Navigation Satellite System signals and Bluetooth signals may be reduced. For example, high-performance GPS signal reception and stable and effective Bluetooth communication may be achieved in a smartwatch.

Optionally, the ring radiator 100 further includes a fifth ground node 300 (not shown in the figures), and the fifth ground node 300 is located between the first ground node 301 and the third ground node 303. Optionally, the ring radiator 100 may include the fourth ground node 304 and the fifth ground node 300. The fifth ground node 300 is disposed between the third radiating portion and each of the first radiating portion and the second radiating portion, which helps improve the isolation between the third radiating portion and each of the first radiating portion and the second radiating portion. For example, signal interference between Global Navigation Satellite System signals and Bluetooth signals may be reduced. For example, high-performance GPS signal reception and stable and effective Bluetooth communication may be achieved in a smartwatch.

The antenna assembly provided in embodiments of the present disclosure includes a ring radiator 100 and a first matching circuit 30. The ring radiator 100 includes at least a first feed node 201, a first ground node 301, and a second ground node 302. The ring radiator 100 further includes a first radiating portion 10 and a second radiating portion 20. The first radiating portion 10 is configured to transmit signals in a first operating frequency band, and the second radiating portion 20 is configured to transmit signals in a second operating frequency band. The first radiating portion 10 includes an arc segment located between the first feed node 201 and the first ground node 301. The second radiating portion 20 includes an arc segment located between the first ground node 301 and the second ground node 302. The first feed node 201 is grounded via the first matching circuit 30, and the first matching circuit 30 is a capacitive circuit or an inductive circuit. The first radiating portion 10 and the second radiating portion 20 of the ring radiator 100 are configured to share the same ground node 300, namely the first ground node 301, which can reduce the lengths of arc segments occupied on the ring radiator 100 by the first radiating portion 10 for transmitting signals in the first operating frequency band and the second radiating portion 20 for transmitting signals in the second operating frequency band. The first feed node 201 is configured to be grounded via the first matching circuit 30, which can adjust the impedance of the first radiating portion 10 with respect to signals in the first operating frequency band and the impedance of the second radiating portion 20 with respect to signals in the second operating frequency band, so as to improve the overall radiation efficiency of the antenna assembly for signals in the first operating frequency band and the second operating frequency band.

In some embodiments, the first radiating portion 10 and the second radiating portion 20 are arranged in a co-aperture manner on the ring radiator 100, which can reduce the lengths of arc segments occupied on the ring radiator 100 by the first radiating portion 10 for transmitting signals in the first operating frequency band and the second radiating portion 20 for transmitting signals in the second operating frequency band.

It should be noted that the reliability and accuracy of signal reception of a Global Navigation Satellite System (such as Global Positioning System, GPS) are critical to the performance of a smartwatch. To improve signal reception quality, a GPS antenna often employs right-hand circular polarization (RHCP), which helps electronic devices such as smartwatches receive satellite signals from different directions and polarization angles under various motion states and angles, so as to maximize resistance to multipath interference and signal attenuation. Since an antenna for a Global Navigation Satellite System needs to achieve right-hand circular polarization, only feeds at specific positions and specific arc segments on the ring radiator 100 have a high axial ratio, that is, an antenna with strong right-hand polarization performance has a designated position on the metal ring. Since the first radiating portion 10 and the second radiating portion 20 in embodiments of the present disclosure are arranged in a co-aperture manner, for example, the L1 frequency band and the L5 frequency band share one radiating portion, the L1 frequency band and the L5 frequency band can maintain a high right-hand axial ratio at the same time.

In some embodiments, reducing the lengths of arc segments occupied by the first radiating portion 10 and the second radiating portion 20 can facilitate the arrangement of radiating portions with respect to signals in other operating frequency bands, such as a radiating portion for Bluetooth signals, on other arc segments of the ring radiator 100, thus improving the integration of the antenna assembly.

In the related art, an antenna for the L1 frequency band and an antenna for the L5 frequency band are respectively disposed in different arc segments of the ring radiator 100, and most arc segments of the ring radiator 100 are occupied by the GPS antenna, resulting in limited installation space for a Bluetooth antenna. For small-sized wearable devices, the Bluetooth antenna can only be disposed in an arc segment of the L1-band antenna or the L5-band antenna. However, since the Bluetooth antenna and the GPS antenna share the same radiation aperture, mutual interference between Bluetooth and GPS signals often occurs, which not only increases the complexity of antenna design and debugging, but may also degrade the performance of the GPS antenna. Alternatively, the Bluetooth antenna may be an antenna of another type, such as a flexible printed circuit (FPC) antenna. However, when a Bluetooth antenna of another type is adopted, the position of the antenna must be readjusted, which poses a challenge given the limited internal space of current smart wearable devices. Moreover, the coupling effect between the modified Bluetooth antenna and the GPS antenna is usually difficult to predict and control, bringing additional uncertainties and risks to the design. In the embodiments of the present disclosure, mutual interference between Bluetooth and GPS signals can be reduced by arranging the Bluetooth antenna (third radiating portion 50) and the GPS antenna (first radiating portion 10 and second radiating portion 20) at intervals in different arc segments of the ring radiator 100.

Referring to FIG. 9 in conjunction with the foregoing embodiments, FIG. 9 is a schematic diagram showing an electronic device according to one embodiment of the present disclosure. The electronic device includes the antenna assembly according to the foregoing embodiments.

For example, the electronic device may be a smart wearable device, such as a smartwatch. Certainly, the present disclosure is not limited to this. For example, the electronic device may be a speedometer, a mobile phone, a tablet computer, or the like.

For ease of description, the embodiments of the present disclosure are mainly illustrated using a smartwatch as an example.

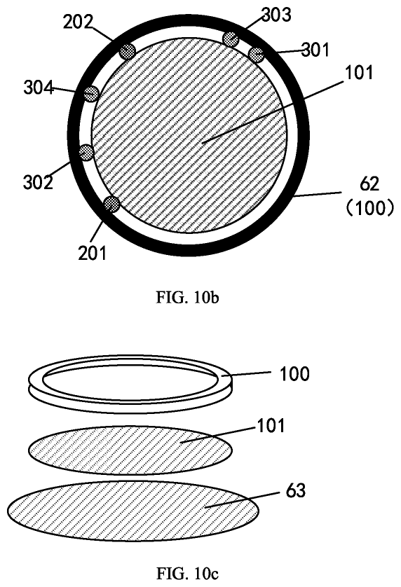

In some embodiments, as shown in FIG. 10a, the electronic device includes a housing 60 and a circuit board 101 disposed in the housing 60. The housing 60 includes a bottom wall 61 and a side wall 62 (which may be referred to as a middle frame) connected to the bottom wall 61.

Optionally, the ring radiator 100 of the antenna assembly may be disposed on an upper edge of the side wall 62, or on an inner wall of the side wall 62. The feed node 200 and the ground node 300 of the ring radiator 100 may be coupled to the circuit board 101 via conductive posts.

Optionally, as shown in FIGS. 10a and 10b, the metal side wall 62 may also be used as the ring radiator 100. The feed node 200 and the ground node 300 of the metal side wall 62 may be coupled to the circuit board 101 via any conductor.

Optionally, as shown in FIG. 10c, the ring radiator 100 is disposed on one side of the circuit board 101, and a metal base plate 63 may be disposed on an opposite side of the circuit board 101. For example, the bottom wall 61 of the electronic device housing 60 may be configured as the metal base plate 63. Certainly, the present disclosure is not limited to this. For example, the ring radiator 100 may be disposed between the circuit board 101 and the metal base plate 63. By providing the metal base plate 63, the antenna performance of the antenna assembly can be improved. For example, when the electronic device is worn on a human body, the metal base plate 63 can generate a reverse current with a ground layer of the circuit board 101, reducing the magnetic field energy entering the human body, and thus improving the radiation performance of the GPS antenna.

Specific principles and implementation manners of the electronic device provided in embodiments of the present disclosure are similar to those of the antenna assembly according to the foregoing embodiments, and will not be described in detail here.

It should be understood that the terms used herein are for the purpose of describing particular embodiments and are not intended to limit the present disclosure.

It should be understood that when an element or layer is referred to as being “on,” “adjacent to,” “connected to,” or “coupled to” another element(s) or layer(s), it can be directly on, adjacent to, connected to, or coupled to another element(s) or layer(s), or there may be an intervening element or layer. In contrast, when an element is described as being “directly on,” “directly adjacent to,” “directly connected to,” or “directly coupled to” another element(s) or layer(s), there are no intervening elements or layers present. It should be understood that, although the terms first, second, third, etc. may be used herein to describe various elements, components, regions, layers, and/or portions, these elements, components, regions, layers, and/or portions should not be limited by these terms. These terms are used to distinguish one element, component, region, layer, or portion from another element(s), component(s), region, layer, or portion. Thus, a first element, component, region, layer, or portion discussed below may be represented as a second element, component, region, layer, or portion without departing from the teachings of the present disclosure.

Spatially relative terms, such as “beneath,” “below,” “lower,” “under,” “above,” “upper,” and the like, may be used herein for ease of description to describe a relationship between one element or feature and another element(s) or feature(s) shown in the figures. It should be understood that, in addition to the orientations shown in the figure, the spatially relative terms are intended to include different orientations of devices in use or operation. For example, when the device in the figures is turned over, then an element or a feature described as “below” or “under,” or “beneath” another element(s) or feature(s) would be oriented “above” another element(s) or feature(s). Thus, the exemplary terms “below” and “under” can include both an orientation of above and below. The device may be otherwise oriented (rotated 90 degrees or other orientations) and the spatially relative descriptors used herein shall be interpreted accordingly.

The terminology used herein is for the purpose of describing particular embodiments and is not intended to limit the present disclosure. As used herein, the singular forms “a.” “an,” and “the” are also intended to include the plural forms as well, unless the context clearly indicates otherwise. It should also be understood that the terms “comprise” and/or “include,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The above description is a specific embodiment of the present disclosure, but the scope of protection of the present disclosure is not limited thereto. Any person skilled in the art can readily conceive of various equivalent modifications or substitutions within the technical scope disclosed in the present disclosure, and such modifications or substitutions shall fall within the scope of protection of the present disclosure.

What is claimed is:

1. An antenna assembly, comprising:
a ring radiator, the ring radiator comprising at least a first feed node, a first ground node, and a second ground node;
the ring radiator comprising a first radiating portion and a second radiating portion, the first radiating portion being configured to transmit signals in a first operating frequency band, and the second radiating portion being configured to transmit signals in a second operating frequency band;
the first radiating portion comprising an arc segment located between the first feed node and the first ground node;
the second radiating portion comprising an arc segment located between the first ground node and the second ground node; and
a first matching circuit, wherein the first feed node is grounded via the first matching circuit, and the first matching circuit is a capacitive circuit or an inductive circuit.

2. The antenna assembly according to claim 1, wherein the first operating frequency band is a frequency band of a Global Navigation Satellite System, and the second operating frequency band is another frequency band of the Global Navigation Satellite System.

3. The antenna assembly according to claim 2, wherein the length of the first radiating portion is ¼ of the wavelength corresponding to a target frequency, wherein the target frequency is greater than a center frequency of the second operating frequency band and less than a center frequency of the first operating frequency band.

4. The antenna assembly according to claim 1, further comprising a second matching circuit, the second ground node being grounded via the second matching circuit.

5.-11. (canceled)

12. The antenna assembly according to claim 4, wherein the second matching circuit comprises a capacitor and an inductor, and the capacitor and the inductor are connected in parallel.

13. The antenna assembly according to claim 4, wherein the second matching circuit is a capacitive circuit or an inductive circuit.

14. The antenna assembly according to claim 1, wherein the first matching circuit comprises a capacitor and an inductor, and the capacitor and the inductor are connected in parallel.

15. The antenna assembly according to claim 1, wherein the length of an arc segment between the first feed node and the first ground node is less than the length of an arc segment between the first ground node and the second ground node.

16. The antenna assembly according to claim 1, wherein the ring radiator comprises a first arc segment and a second arc segment between the first ground node and the second ground node;
the first feed node is disposed on the first arc segment;
the antenna assembly further comprises a second feed node and a third ground node disposed on the second arc segment;
the ring radiator further comprises a third radiating portion, the third radiating portion comprising a portion of the second arc segment located between the second feed node and the third ground node; and
the third radiating portion is configured to transmit signals in a third operating frequency band.

17. The antenna assembly according to claim 16, wherein the third operating frequency band is a Bluetooth or WiFi frequency band.

18. The antenna assembly according to claim 16, wherein the length of an arc segment between the third ground node and the first ground node is less than the length of an arc segment between the second feed node and the first ground node.

19. The antenna assembly according to claim 16, wherein the ring radiator further comprises a fourth ground node, the fourth ground node being located between the second feed node and the second ground node.

20. The antenna assembly according to claim 16, wherein the ring radiator further comprises a fifth ground node, the fifth ground node being located between the first ground node and the third ground node.

21. The antenna assembly according to claim 16, wherein a ground node of the third radiating portion is disposed adjacent to the ground node(s) of the first radiating portion and the second radiating portion, and a feed node of the third radiating portion is disposed adjacent to the feed node(s) of the first radiating portion and the second radiating portion.

22. The antenna assembly according to claim 1, wherein the first radiating portion and the second radiating portion share the first ground node.

23. The antenna assembly according to claim 1, wherein the ring radiator further comprises a fourth radiating portion configured to transmit signals in a fourth operating frequency band.

24. The antenna assembly according to claim 1, wherein a resonant frequency corresponding to the first radiating portion is greater than 1.1 times a center frequency of the second operating frequency band and less than 0.9 times a center frequency of the first operating frequency band.

25. The antenna assembly according to claim 1, wherein the first radiating portion and the second radiating portion are arranged in a co-aperture manner.

26. The antenna assembly according to claim 1, wherein the first radiating portion and the second radiating portion are arranged in a co-aperture manner on the ring radiator.

27. An electronic device, comprising an antenna assembly, the antenna assembly comprising:
a ring radiator, the ring radiator comprising at least a first feed node, a first ground node, and a second ground node;
the ring radiator comprising a first radiating portion and a second radiating portion, the first radiating portion being configured to transmit signals in a first operating frequency band, and the second radiating portion being configured to transmit signals in a second operating frequency band;
the first radiating portion comprising an arc segment located between the first feed node and the first ground node;
the second radiating portion comprising an arc segment located between the first ground node and the second ground node; and
a first matching circuit, wherein the first feed node is grounded via the first matching circuit, and the first matching circuit is a capacitive circuit or an inductive circuit.
